(19) United States
(12) Patent Application Publication
(10) Pub. No.: US 2006/0095470 A1
(43) Pub. Date: May 4, 2006

(54) Managing a file in a network environment

(76) Inventors: Robert A. Cochran, Sacramento, CA (US); John Wilkes, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/981,005

(22) Filed: Nov. 4, 2004

(51) Int. Cl. G06F 17/00

(52) U.S. Cl. 707/104.1

(57) ABSTRACT

A method of managing storage of a file in a network environment includes storing, in a central repository, tracking information of copies of the file on storage server systems in the network environment. The tracking information in the central repository is used to identify plural copies of the file. Information pertaining to the plural copies of the file is communicated to a client system. One or more requests responsive to the information pertaining to the plural copies of the file are received from the client system to delete one or more of the copies of the file.

### BACKGROUND

In a typical enterprise (such as a company, a university, a government agency, and so forth), computer systems communicate with each other in a network environment. The network environment includes one or more networks, such as local area networks (LANs) and/or wide area networks (WANs). The computer systems include client systems (at which users are typically located) and server systems, such as storage server systems that include storage devices to store data in the network environment.

Files, such as databases or other types of files, can be stored in the storage devices. In a large enterprise, the network environment can include a large number of storage server systems that are distributed throughout the enterprise. For example, the network environment may include a central site and several remote sites, with each of the sites including one or more networks coupled to one or more respective storage server systems. For ease of access, multiple copies of files can be stored on multiple storage server systems at the various sites. In some cases, there can be a large number of identical copies of such files within the enterprise, which is wasteful of storage resources in the network environment. Also, as a result of maintaining a large number of duplicate copies of files throughout the enterprise, a backup of each of the duplicate copies of the files may be performed periodically, such as nightly. The unnecessary backup of multiple duplicate copies of the files may take a large amount of time to perform and is also wasteful of backup storage resources.

A further concern associated with a network environment is unauthorized access of stored data, such as the files stored in the storage server systems. Unauthorized access of data in a network environment typically involves an outside user (a user located outside the network environment) obtaining unauthorized access of the network environment to maliciously modify data. Unauthorized access can also be performed from within the network environment. A user that gains unauthorized access to data for the purpose of maliciously modifying or deleting the data is often referred to as a “hacker.” Normally, it is difficult to determine whether a particular file has been modified by a hacker. Conventionally, a convenient mechanism has not been provided to detect if a particular file in a network environment has been modified by a hacker.

Also, a network environment often keeps a mirrored or backup copy of a primary file for purposes of redundancy in case the primary file is corrupted or in case the storage server system on which the primary file is located exhibits a failure. The mirroring process typically involves the copying of the primary file on one storage server system (primary storage server system) to a separate backup storage server system. In some cases, before a complete copy of the primary file has been made, a failure may cause some data to be lost in transit between the primary storage server system and the backup storage server system. Normally, a user of the backup file may have no way of knowing how much data was actually lost in transit.

### BRIEF DESCRIPTION OF THE DRAWINGS

FIG. 1 is a block diagram of a network environment that incorporates an embodiment of the invention.

FIGS. 2A-2B show a flow diagram of a process performed in the network environment, in accordance with an embodiment of the invention.

### DETAILED DESCRIPTION

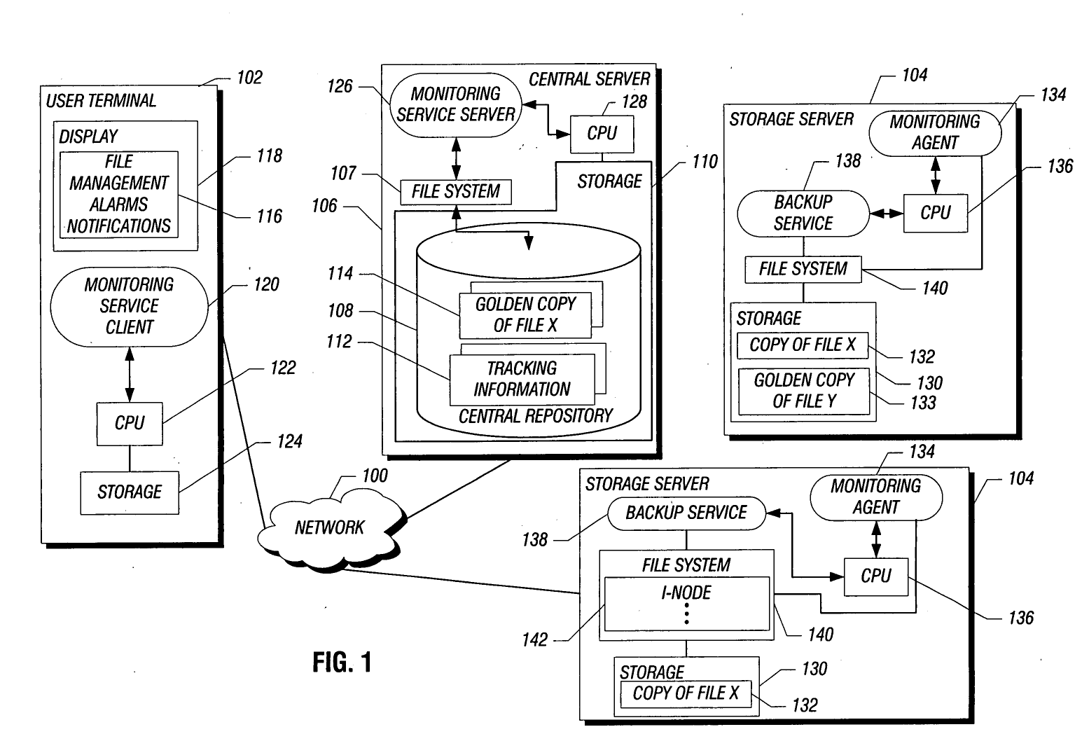

FIG. 1 illustrates multiple computer systems connected to a network 100. The network 100 represents one or multiple networks associated with an enterprise for communicating data and/or any other form of electronic communications. An “enterprise” refers to any organization, such as a company, educational facility, government agency, and so forth, that utilizes computer systems coupled to one or more networks. Examples of networks include local area networks (LANs), wide area networks (WANs), storage area networks, the Internet, and other types of networks. The network 100 depicted in FIG. 1 can represent a collection of networks in which one or more networks are part of a central site of the enterprise, and one or more other networks are part of one or more remote sites of the enterprise.

The computer systems depicted in FIG. 1 that are connected to the network 100 include a user terminal 102 (also referred to as a client system), storage server systems 104, and a central server system 106. Although two server storage systems 104 are depicted in FIG. 1, it is contemplated that some embodiments of the invention are applicable to a network environment that includes a smaller number of storage server systems 104 or a larger number of storage server systems 104. Also, although one user terminal 102 is depicted in FIG. 1, it is contemplated that additional user terminals can be provided in other embodiments. Similarly, more than one central server system 106 can be provided in the network environment.

The central server system 106 includes a central repository 108 to store tracking information and other information associated with selected files in the network environment, in accordance with some embodiments of the invention. A “file” refers to any collection of data, such as a database, a document, a table, or other forms of data. The central repository 108 refers to a central place (in this case the central server system 106) where data is stored and maintained, with the repository 108 able to store multiple files or other forms of information for access by computer systems over the network 100. The central repository 108 can be contained in storage 110 of the central server system 106. The storage 110 can be any type of storage medium, such as one or more hard disk drives or other types of magnetic drives, one or more optical drives, one or more integrated circuit (IC) storage devices, and so forth. The monitoring service server 126 accesses the central repository 108 stored in storage 110 through a file system 107. A “file system” refers to a mechanism that defines data structure(s) for translating the physical view of storage device(s) into logical (e.g., files, directories) structure(s), which a software application and user can more easily use to locate files. “File system” can also mean some or all of a database (e.g., a database table space or a database table), a logical volume store (e.g., a logical volume manager, or the virtualization portions of a disk array), or any other form of structured data store.

In an alternative embodiment, the central repository 108 can be distributed across multiple central server systems, with each portion of the central repository in a particular central server system containing a subset of the information of the central repository 108.

The central repository 108 includes plural sets of tracking information 112 for respective files stored in storage servers 104 of the network environment. In one example, the tracking information 112 includes a signature (e.g., a hash signature) of the file, a size of the file, a name of the file, an identifier of the registered owner of the file, and a location of the file. A hash signature of a file is created by applying an input associated with the file (such as the entire content of the file) through a hashing algorithm. Various hashing algorithms may be used, such as the MD5 (Message-Digest) algorithm. The MD5 algorithm creates a 128-bit message digest from a predefined data input, where the message digest is unique to the specific data input. As the content of the file changes, the hash signature of the file can be recomputed to different values. In other embodiments, instead of using a hash signature, another type of unique signature based on the content of the file can be used.

In accordance with some embodiments of the invention, the signature of the file is used to detect duplicate copies of a file, as well as to detect for unauthorized modification of a file by a hacker.

The central repository 108 is also used to store a “golden” or “master” copy of a file 114, such as a golden copy of file X. As used here, the terms “golden copy” and “master copy” refer to a copy of a file maintained in a known or otherwise discoverable location in a network environment. The golden or master copy can be used to replicate a file to multiple locations in the network environment, if desired. Additionally, in case of corruption or inadvertent deletion of other copies of the file in the network environment, the golden or master copy can be used to restore the corrupted or deleted file. The terms “golden copy” and “master copy” are used interchangeably.

For multiple files in the network environment, golden copies of the respective files are maintained in the central repository 108. Note that a golden copy of a file can be stored either in the central repository 108 or in another location in the network environment, such as in a storage server system 104.

To avoid maintaining a large number of files for which golden copies and tracking information have to be maintained in the central repository 108 or elsewhere in the network environment, a user (or users) can register selected files for which respective sets of tracking information 112 and golden copies 114 are to be maintained. Alternatively, the user can register selected files for which respective sets of tracking information 112 and golden copies 114 are not to be maintained, or some combination of the above. Files can be selected in any of many ways, such as by file name, by pattern, by owner, by size, by modification date or frequency, and so on. The central repository service (and associated monitoring service) can be subscribed to by a user (or users). Each subscriber can then register files that the user wishes to track and monitor. Additionally, system operators or other administrators, such as system managers, user-group representatives, owners, and so forth, can register files on behalf of users, or apply default or mandated policies that set the files to be monitored or not monitored. These sets can have rules applied to allow them to be composed.

Subscription and registering can be performed through the user terminal 102 (or other like user terminals in the network environment). The user terminal 102 includes a display 118 in which a user interface (such as a graphical user interface or GUI) 116 can be displayed. The user interface 116 can display information regarding files to be monitored (referred to as “monitored files”) in the network environment. For example, the user interface 116 can display notifications regarding how many duplicate copies of a monitored file are present in the network environment.

Also, the user interface 116 can display alarms associated with monitored files of the network environment. These alarms can indicate that a particular file has been corrupted or modified without authorization, or that multiple copies of the particular file exist, or that a new copy has been created. Through the user interface 116, a user can select which duplicate copies of the file are to be deleted. Other file management tasks can also be performed using the user interface 116 in the display 118, as discussed further below.

The user interface 116 can be provided in more than one user terminal 102 to enable multiple users to perform file management according to some embodiments of the invention.

The user terminal 102 also includes a monitoring service client 120, which can include one or more software modules, that is executable on a central processing unit (CPU) 122. The CPU 122 is connected to storage 124 (e.g., memory). The storage 124 can also include persistent storage coupled to the CPU 122. The monitoring service client 120 is capable of communicating over the network 100 with a monitoring service server 126 in the central server system 106. The monitoring service server 126, which includes one or more software modules, is executable on a CPU 128 in the central server system 106. The CPU 128 is connected to the storage 110. The monitoring service client 120 interacts with the monitoring service server 126 to register files for monitoring and other file management tasks, based on user input at the user interface 116 of the user terminal 102 (or of other user terminals). Based on user input communicated from the monitoring service client 120 to the monitoring service server 126, the monitoring service server 126 performs predefined monitoring and other file management tasks with respect to monitored files.

The monitoring service server 126 may monitor the unique signatures of monitored files in the network environment to determine how many duplicate copies of each monitored file exist in the network environment. A duplicate copy of a file is one where the signatures of the files match identically. Also, for selected monitored files, the monitoring service server 126 determines if each of such monitored file has been modified, where the monitored file should have remained un-altered. A monitored file that should not be modified (at least for some predefined period of time) is referred to as a “static file.”

Each of the storage server systems 104 includes storage 130. In the example of FIG. 1, each storage 130 of each respective storage server system 104 contains a copy of file X 132. The copies of file X 132 in the storage server systems 104 are duplicate copies of file X. In fact, each copy of file X 132 in the storage server system 104 is a duplicate of the golden copy of file X 114 contained in the central repository 108. Also, a golden copy of file Y 133 can also be stored in the storage 130 of one of the storage server systems 104.

Each storage server system 104 contains a monitoring agent 134 that is capable of communicating with the monitoring service server 126 in the central server system 106. In response to requests from the monitoring service server 126, the monitoring agent 134 performs monitoring and other file management tasks with respect to files stored in the corresponding storage server system 104. The monitoring agent 134 is a software module that is executable on a CPU 136 in each storage server system 104. As an example, the monitoring service server 126 in the central server system 106 can send requests to the monitoring agent 134 to monitor the copy of file X 132 in the storage 130, to update a signature of the copy of file X 132, to retrieve other tracking information of the copy of file X 132, or to perform other management tasks.

The storage server system 104 may also contain a backup service module 138, which can be a software module executable on the CPU 136. The backup service module 138 performs backup of data contained in storage 130 of the storage server 104. For example, the backup service module 138 can back up the copy of file X 132, along with other files and data, to backup storage media, such as tape drives, optical drives, and so forth. The monitoring agent 134 and backup service module 138 access data contained in the storage 130 through a file system 140. The backup service module 138 can be instructed by the monitoring service server 126 to perform backups of certain files and not to perform backups of other files. For example, since the copy of file X 132 is a duplicate, the monitoring service server 126 can instruct the corresponding backup service module 138 not to perform backups of the copy of file X to conserve backup storage media resources and to avoid wasting of time in backing up a duplicate copy of a file that is already backed up elsewhere. For example, a network administrator or other user can select that backups be performed of golden copies of files (if available) or of only one of the duplicate copies of files stored on multiple storage servers systems (if the golden copy does not exist).

Each file system 140 of a storage server system 104 includes one or more i-nodes 142. An i-node is a data structure that contains information about a particular file. Each file typically is associated with an i-node and is identified by an i-node number (i-number) in the file system 140. Conventionally, the i-node for each file is maintained for a file that is actually stored in the storage 130 of the storage server system 104. In other words, conventionally, if a file is not present in a particular system, then an i-node would not be maintained for that file in the system. Although an i-node data structure is used for expository purposes here, any equivalent data structure or data structures whose purpose is/are to record metadata about files may be substituted for an i-node.

However, in accordance with some embodiments of the invention, an i-node 142 can be maintained in the file system 140 of a storage server system 104 for a file that is not present in the storage server system 104. The i-node 142 according to some embodiments of the invention can contain a locator identifier, such as a uniform resource locator (URL) or other similar locator identifier, that identifies a location of the file associated with the i-node 142. The location identifier in the i-node 142 can point, for example, to the golden copy of the corresponding file in the central repository 108, or to another copy of a file on another storage server system 104.

In response to a request received by a first storage server system 104 for the file associated with the i-node 142, the monitoring agent 134 in the first storage server system 104 sends a request for the actual file to the appropriate server system if the file is not stored locally, such as central server system 106 or another storage server system 104. The monitoring agent 134 sends a request for this file based on the location identifier in the i-node 142. The requested file is retrieved over the network 100 and may be stored in the storage 130 of the first storage server system 104; the first storage server system 104 then responds to the received request by accessing the copied version of the file in the first storage server system 104. Alternatively, the file may simply be delivered to the client without also being stored first in storage server system 104. By employing the i-node 140 containing the location identifier for a file that is not stored in the storage server system 104, the i-node 142 in effect becomes a placeholder for the file such that the storage server system 104 in which the i-node 142 is located does not actually have to store the file. This structure enables more efficient utilization of storage resources since a file is not copied to the storage server system 104 until the file is requested by a user. Thus, effectively, the i-node 142 provides a placeholder without any real content of the file stored in the storage server system 104.

For redundancy, it is often desirable to enable files stored on one storage server system 104 to be mirrored or copied to another storage server system 104. For example, one storage server system 104 can be identified as a primary storage server system, while another storage server system can be identified as a backup storage server system. The primary storage server system contains primary copies of selected files, while the backup storage server system contains backup copies of the selected files. Periodically, or by being triggered when a change occurs, updated data stored in the primary storage server system is copied to the backup storage server system over the network 100. (The copy may include just the updated data or all of it, or anything in between.) When a failure occurs in the primary storage server system, failover may occur from the primary storage server system to the backup storage server system such that users can continue to have access to the selected files.

In the mirroring process from the primary storage server system to the backup storage server system, a portion of a primary file stored in the primary storage server system may be buffered in the primary storage server system and may not have yet been transferred over to the backup storage server system. The buffered portion of the primary file is considered data in transit from the primary storage server system to the backup storage server system. Thus, when failing over to a backup copy of a file, a certain portion of the file may have been lost in transit due to loss of the buffered data as a result of failure of the primary storage server system. The monitoring service server 126, in combination with the monitoring agent 134, enables a user to determine how much data of a file has been lost in transit when failing over to a backup copy of the file. One technique for performing this determination is to compare the size of the file maintained in the set of tracking information 112 with the actual size of the backup copy of the file stored in the backup storage server system. The difference in sizes indicates the amount of data that has been lost in transit.

The file system 107 of the central server system 106 is also configured to refuse or reject any request to delete a golden copy of a file 114 unless predetermined special steps are taken. For example, deletion of the golden copy of a file cannot occur unless a group of predefined users all agree to the deletion of the golden copy of the file. Additionally, a request to delete a golden copy of a file on a storage server system 104 may be refused unless the golden copy of the file, such as the golden copy of file Y 133, is first moved to the central repository 108. Further, passwords, user verification, and other security and identification protocols may be implemented before authorizing deletion of a golden copy of a file.

A further service that is provided by the monitoring service server 126 and monitoring agents 134 is the automated restoration of a monitored file that has been altered or deleted inadvertently or maliciously. For example, the monitoring service server 126 or monitoring agents 134 can periodically recall and check the signature of a static monitored file (or any other file, static or not, that is to be monitored) against the tracking finformation 112. If alteration or deletion of such a static monitored file is detected, then the monitoring service server 126 may initiate an automatic restoration of the altered or deleted monitored file. Alternatively, the monitoring service server 126 can communicate with the monitoring service client 120 in the user terminal 102 to provide a user with the option of restoring the altered or deleted static monitored file. As yet another alternative, the monitoring service server 126 may simply notify the user, or just log the event for later analysis. Once restoration has been performed, the monitoring service server 126 may send a notification to the monitoring service client 120, which displays the notification in the user interface 116 to alert the user that a restore operation has been performed with respect to a static monitored file that has been inadvertently or maliciously altered or deleted.

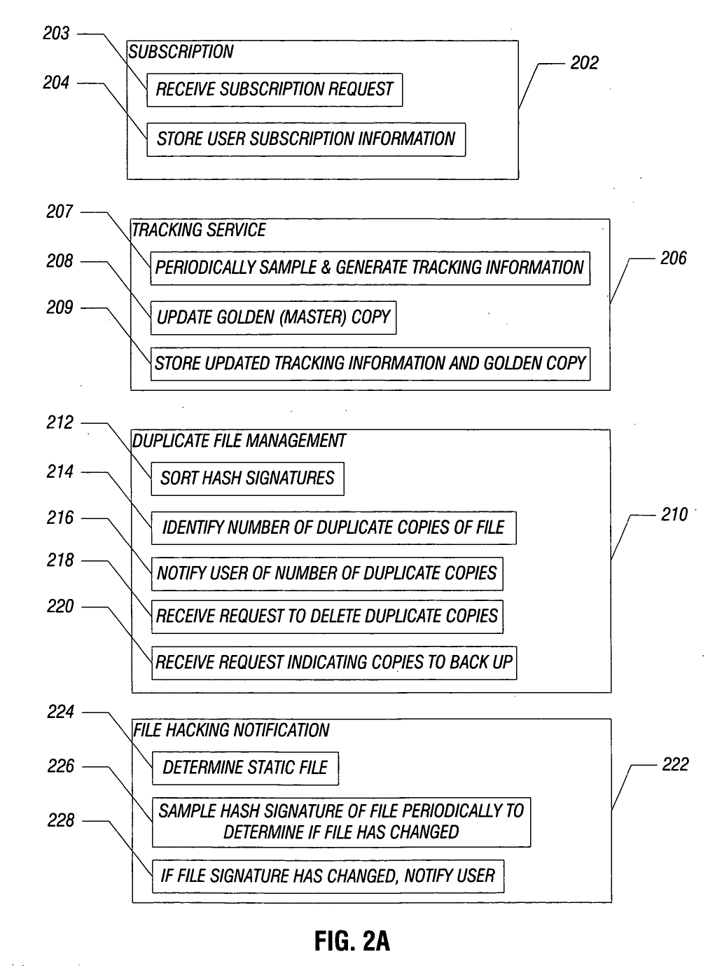

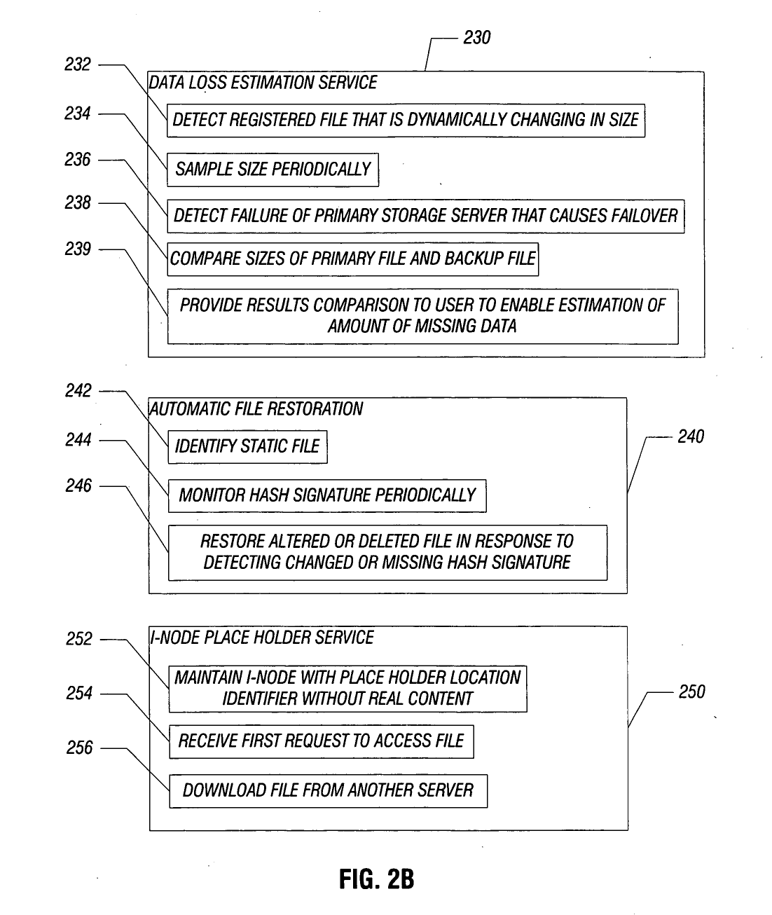

FIGS. 2A-2B illustrate a process that can be performed in the network arrangement of FIG. 1, according to some embodiments. In the following discussion, reference is made to FIGS. 1, 2A, and 2B. A user can subscribe (at 202) to the monitoring and other file management services that are provided by the monitoring service server 126 and associated agents. In response to a user request (received at 203) to subscribe to such services (submitted through the user terminal 102 and monitoring service client 120), the monitoring service server 126 stores (at 204) the user subscription information indicating subscription to the monitoring and other file management services. Such subscription information may include a list of monitored files that the user wishes to be monitored or managed. Additionally (not shown) the user may supply or modify this subscription information at a later time or times. And the user may be able to query or retrieve information about the subscription information the system maintains for them.

One service provided by the monitoring service server 126 is a tracking service 206. In performing the tracking service 206, the monitoring service server 126 periodically samples (at 207) and generates tracking information 112, including the signature of each file, the size of each file, the name of each file, the identifier of the registered owner of each file, and the location of each file. During operation of the network environment, the monitored files may be changed by authorized users (such as by updating a database, deleting entries of a database, updating a table or deleting entries of a table, and so forth). As a result of the change to the content of each monitored file, the signature and size of such monitored file may change. Also, the location of the monitored file may be moved. Consequently, the tracking information of the monitored file stored in the central repository 108 is updated. The user can specify the amount of time between samplings of each monitored file. Additionally, in response to an authorized update of a monitored file, the golden copy of such a file is also updated (at 208). The updated tracking information and golden copy of the file are stored (at 209) in the central repository 108. Note that the tracking information and/or golden copy of the file can be stored on a storage server system 104 instead.

Another service provided by the monitoring service server 126 is a duplicate file management service 210. Signatures of all copies of monitored files are sorted (at 212) in the central repository 108. The signatures of copies of the monitored files can be stored into a table and sorted. Duplicate copies of a monitored file have identical signatures. Based on matches of signatures in the central repository 108, the monitoring service server 126 is able to identify (at 214) the number and location of duplicate copies of each monitored file. The monitoring service server 126 then notifies (at 216) the user (through monitoring service client 120) of the number of duplicate copies of the monitored file present in the network environment.

Based on the notification of the number of duplicate copies of the monitored file, the user can issue requests to delete one or more of the duplicate copies of the monitored file. Upon receiving (at 218) the request to delete one or more duplicate copies of the monitored file, the monitoring service server 126 performs the requested deletion by sending requests to the appropriate storage server systems 104. Also, the user can specify which duplicate copies of the monitored file are to be backed up, so that not all duplicate copies of the monitored file are backed up by the respective storage server systems 104. Upon receiving (at 220) a request from the monitoring service client 120 indicating which of the duplicate copies of the monitored file to back up, and which to not back up, the monitoring service server 126 sends commands to appropriate ones of the backup service modules 138 in respective storage server systems 104. The commands indicate whether or not the corresponding backup service module 138 is to back up the copy of each monitored file contained in the storage 130 of the storage server system 104.

If the user does not desire to rely on a calculated hash value to positively identify “identical” files, the hash value may be used merely to detect whether a collision has probably occurred, and a more careful check can be run to determine if the contents are in fact the same—e.g., the two potentially similar copies may be compared directly in their entirety, or parts of them may be compared. This principle can be applied anywhere that “identical” objects are detected by comparing the results of a hash function. If so desired, after a copy of a file has been deleted, its name can be re-linked to a local (or remote) copy of the file in any of a number of ways—e.g., by using standard techniques supported by the file system, or by using reference information stored in an i-node. In this way, the original access path to the copy can be preserved, which can avoid requiring changes in programs, scripts, or user behavior.

Yet another service provided by the monitoring service server 126 is a file hacking notification service 222. The monitoring service server 126 determines (at 224) one or more monitored files that are static. A static file is a file that is not supposed to change within some predetermined time period. For each such static file (or for any non-static file that is to be monitored), the monitoring service server 126 samples (at 226) the signature of each such file on a periodic basis to determine if the file has changed. If the file signature has changed, then that is an indication that the content of the corresponding file has been changed without authorization. As a result, the monitoring service server 126 sends (at 228) a notification to the monitoring service client 120 in the user terminal 102 to present the notification in the user interface 116 of the user terminal 102.

The monitoring service server 126 also performs data loss estimation, indicated generally as 230. The data loss estimation service is provided to enable a user to determine how much data is lost in transit in response to a failover from a primary storage server system to a backup storage server system. To perform this service, the monitoring service server 126 detects (at 232) each monitored file that is dynamically changing in size (that is, a monitored file that is being updated by users during normal operation of the network environment). The monitoring service server 126 periodically samples (at 234) the size of each such monitored file at predefined intervals. The sample sizes are maintained as part of the tracking information 112 in the central repository 108.

Upon detecting failure of a primary storage server system that results in failover to a backup storage server system, the monitoring service server 126 compares (at 238) the size of each primary file (the size information is obtained from the tracking information 112 in the central repository 108) with the size of each corresponding backup file in the backup storage server system. The result of the comparison is provided (at 239) to the user by the monitoring service server 126 through the monitoring service client 120 to enable the user to estimate the amount of missing data (that has been lost in transit).

Yet a further service is an automatic file restoration service 240. The monitoring service server 126 identifies (at 242) one or more monitored files as being static. Periodically, the monitoring service server 126 monitors (at 244) the signature of each such static monitored file. If the static monitored file has been deleted or altered, the monitoring service server 126 initiates (at 246) a restore operation to restore the file from another location in the network environment, such as from the golden copy of the file in the central repository 108 or elsewhere in another storage server system 104.

The file systems 140 in the storage server 104 also provide an i-node placeholder service referred to generally as 250. Each file system 140 is capable of storing (at 252) a placeholder i-node 142 (an i-node without any real content of the corresponding file) that contains a location identifier. Storing an i-node without real content refers to maintaining an i-node in a storage server system where an actual copy of the file associated with the i-node is not present in the storage server system. Note that multiple placeholder i-nodes can be stored in each storage server system for respective files. Upon receiving (at 254) a first request to access the file (that is not present in the storage server system), the file system 140 of the storage server system downloads (at 256) a copy of the file from either the central repository 108 or from another storage server system 104. Alternatively, instead of downloading the copy of the file, the file system 140 can cause the copy of the file to be communicated from either the central repository 108 or another storage server system 104 to another location in the network environment. By using placeholder i-nodes 142 to enable storage of the i-node without real content, each storage server system 104 can potentially reach vast amounts of data in the entire enterprise without having to actually store such data in the storage server system 104.

Instructions of the various software routines or modules discussed herein (such as the monitoring service server 126, monitoring service client 120, monitoring agents 134, and other software components) are executed on corresponding CPUs. The CPUs include microprocessors, microcontrollers, processor modules or subsystems (including one or more microprocessors or microcontrollers), or other control or computing devices. As used here, a “control module” refers to hardware, software, or a combination thereof. A “control module” can refer to a single component or to plural components (whether software or hardware).

Data and instructions (of the various software routines or modules) are stored on one or more machine-readable storage media. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines or modules are loaded or transported to a system in one of many different ways. For example, code segments including instructions stored on floppy disks, CD or DVD media, a hard disk, or transported through a network interface card, modem, or other interface device are loaded into the system and executed as corresponding software modules or layers. In the loading or transport process, data signals that are embodied in carrier waves (transmitted over telephone lines, network lines, wireless links, cables, and the like) communicate the code segments, including instructions, to the system. Such carrier waves are in the form of electrical, optical, acoustical, electromagnetic, or other types of signals.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of managing storage of a file in a network environment, comprising:
storing, in a central repository, tracking information regarding copies of the file on storage server systems in the network environment;
using the tracking information in the central repository to identify plural copies of the file;
communicating, to a client system, information pertaining to the plural copies of the file; and
receiving one or more requests from the client system, in response to the information pertaining to the plural copies of the file, to delete one or more of the copies of the file.

2. The method of claim 1, further comprising:
storing a master copy of the file in the central repository.

3. The method of claim 2, further comprising:
receiving a request to delete the master copy of the file; and
rejecting the request to delete the master copy of the file unless predetermined criteria are satisfied.

4. The method of claim 1, further comprising:
monitoring a signature of a copy of the file;
detecting a change in the signature;
sending a notification, in response to the changed signature, to the client system of alteration of the copy of the file.

5. The method of claim 1, wherein the tracking information includes signatures for the respective copies of the file, wherein using the tracking information in the central repository to identify plural copies of the file comprises:
comparing signatures of the copies of the file; and
identifying the copies based on matches in the signatures.

6. The method of claim 1, further comprising:
periodically monitoring the copies of the file; and
updating the tracking information in the central repository based on the monitoring.

7. The method of claim 1, further comprising:
storing a first copy of the file in a primary storage server system;
storing a second copy of the file in a backup storage server system;
failing over from the primary storage server system to the backup storage server system in response to failure of the primary storage server system; and
determining, based on the tracking information, whether a portion of the first copy was lost in transit prior to updating the second copy.

8. The method of claim 7, wherein determining whether a portion of the first copy was lost in transit is performed by comparing a size of the first copy with a size of the second copy, wherein the sizes of the first copy and second copy are contained in the tracking information.

9. The method of claim 1, further comprising:
storing an i-node for a second file in a first storage server system, the i-node containing a location identifier of the second file, wherein the second file is not stored in the first storage server system.

10. The method of claim 9, further comprising:
receiving, in the first storage server system, a request for accessing the second file; and
in response to the request, using the location identifier in the i-node to retrieve the second file from another storage server system.

11. The method of claim 9, further comprising:
receiving, in the first storage server system, a request for accessing the second file; and
in response to the request, using the location identifier in the i-node to cause the second file to be communicated from a second storage server system to a another location in the network environment.

12. The method of claim 1, further comprising:
receiving one or more requests from the client system, in response to the information pertaining to the plural copies of the file, identifying which of the plural copies to back up and which of the plural copies of the file not to back up.

13. An article comprising at least one storage medium containing instructions when executed cause a first system to:
store a signature of a file stored on a storage server system;
determine that the file is a file that should not be modified;
detect a change in the signature of the file; and
provide an alert of modification of the file in response to the detected change in the signature of the file.

14. The article of claim 13, wherein storing the signature of the file comprises storing a hash signature of the file.

15. The article of claim 13, wherein storing the signature of the file comprises storing the signature as part of tracking information in a central depository stored in a central server system separate from the storage server system.

16. The article of claim 15, wherein providing the alert of modification of the file comprises providing the alert of modification of the file to a client system separate from the central server system and storage server system.

17. The article of claim 13, wherein the instructions when executed cause the first system to further:
automatically restore the file in response to detecting the modification of the file.

18. The article of claim 17, wherein restoring the file comprises restoring the file from a master copy of the file in a central repository of a central server.

19. A system comprising:
a storage;
a file system containing metadata associated with a file not stored in the storage, the metadata having a location identifier; and
a control module to receive a request to access the file and to, in response to the request, retrieve the file from another system using the location identifier.

20. The system of claim 19, wherein the location identifier comprises a uniform resource locator.

21. The system of claim 19, wherein the metadata comprises an i-node, the i-node containing the location identifier.

22. The system of claim 21, wherein the i-node comprises a placeholder i-node maintained in the system without real content of the associated file stored in the system.

23. A system comprising:
a storage to store a central repository containing tracking information regarding plural files;
a control module to:
detect duplicate copies of a first file based on the tracking information,
communicate, to a user terminal, information pertaining to the duplicate copies of the first file, and
receive, from the user terminal in response to the information pertaining to the duplicate copies of the first file, one or more requests, the one or more requests indicating which of the duplicate copies to back up and which of the duplicate copies to not back up.

22. The system of claim 21, wherein the control module is adapted to communicate with backup service modules of respective storage server systems containing respective duplicate copies of the first file to instruct each backup service module whether a respective duplicate copy is to be backed up.

23. The system of claim 21, wherein the tracking information comprises, for each file, at least one of a signature of the file, a name of the file, a size of the file, an identifier of an owner of the file, and location of the file.

24. The system of claim 21, wherein the control module is adapted to receive, from the user terminal in response to the information pertaining to the duplicate copies of the first file, one or more requests to delete one or more of the duplicate copies.
